(19) United States
(12) Patent Application Publication
(10) Pub. No.: US 2023/0321471 A1
(43) Pub. Date: Oct. 12, 2023

(54) SMOKE AND TOXIC GAS SUCTION REMOVAL-TYPE FIREFIGHTING NOZZLE DEVICE

(71) Applicant: KIM, Jung Gyu, Seoul (KR)

(72) Inventor: Sung Woo KIM, Osan-si, Gyeonggi-do (KR)

(73) Assignee: KIM, Jung Gyu, Seoul (KR)

(21) Appl. No.: 18/024,822

(22) PCT Filed: Sep. 6, 2021
(86) PCT No.: PCT/KR2021/012033

§ 371 Date: Mar. 6, 2023

(30) Foreign Application Priority Data
Sep. 4, 2020 (KR) 10-2020-0113265
Sep. 6, 2021 (KR) 10-2021-0118264

(51) Int. Cl. A62C 31/12; B05B 7/00; A62C 31/28

(52) U.S. Cl. CPC A62C 31/12; B05B 7/0087; A62C 31/28

(57) ABSTRACT

A smoke and toxic gas suction removal-type firefighting nozzle device is disclosed. The smoke and toxic gas suction removal-type firefighting nozzle device includes a spray head configured to receive water supplied from a fire hose and spray the water forward through an inner passage, the spray head having a plurality of intake holes that opens the inner passage to the outside, and a gas introduction guider embedded in the spray head and configured to guide an inlet gas flowing into the spray head through the intake hole by the Venturi phenomenon implemented by the sprayed water such that the inlet gas is mixed with water.

### TECHNICAL FIELD

The present invention relates to a firefighting nozzle device, which is one of fire extinguishing devices, and more particularly, to a smoke and toxic gas suction removal-type firefighting nozzle device, which sucks ambient smoke and toxic gas while spraying water and applies toxic gas, which is dissolved in or mixed with the water, into flames, thereby assisting in ensuring a visual field of a firefighter, minimizing damage caused by the toxic gas, and more efficiently extinguishing a fire than a case in which only water is sprayed.

### BACKGROUND ART

A firefighting nozzle, which is called a fire nozzle among several devices used to extinguish a fire, is a device mounted at an end of a fire hose and configured to spray water, which is supplied through the fire hose, into flames. There are various types of firefighting nozzles. Among them, there are a direct spray nozzle having a relatively simple structure, and a pistol-type nozzle mainly used by a firefighter and having a handle, a lever, a reflector, and the like. The pistol-type nozzle may adjust a water spray angle, a water flow rate, or the like.

Meanwhile, the firefighter inevitably encounters flames and toxic gas when the firefighter enters a building to extinguish a fire. The firefighter may mitigate flames or intense heat to some extent by spraying water thereto but may take no appropriate measures to cope with the toxic gas. The toxic gas has fatal toxicity to a human body. Moreover, the toxic gas hinders the visual field, which makes it difficult to extinguish a fire.

As a technology that constitutes the background related to a fire extinguishing nozzle device, there is Korean Patent No. 10-1780221 entitled “Firefighting Nozzle”.

The disclosed firefighting nozzle includes an opening/closing member disposed at a rear end of the firefighting nozzle and connected to a fire hose, and a nozzle member connected to a tip of the opening/closing member. The nozzle member includes a nozzle having a rear end fastened to the tip of the opening/closing member, a cover body supported to be movable forward or rearward relative to the nozzle, a movable spindle configured to open or close the tip of the nozzle and supported to be movable forward or rearward relative to the nozzle, and a rear spring configured to apply elasticity in a direction in which the movable spindle is pulled rearward relative to the nozzle. The nozzle includes a fixed nozzle fastened to the opening/closing member, and a movable nozzle supported to be movable forward or rearward relative to the fixed nozzle. The rear spring is installed between the fixed nozzle and the movable spindle, the movable spindle opens or closes the tip of the movable nozzle, and a front spring is configured to apply elasticity in a direction in which the movable nozzle is pushed forward relative to the fixed nozzle.

The firefighting nozzle in the related art only has a mechanical structure that absorbs a counteraction of the firefighting nozzle at the time of spraying water. However, the firefighting nozzle does not propose a technology related to a configuration for removing toxic gas produced in the event of a fire.

There is a need for a nozzle device having a structure for spraying water and removing smoke and toxic gas in order to ensure a visual field of a firefighter who extinguishes a fire, save human lives, and improve working efficiency and the firefighter's health.

### DISCLOSURE

### Technical Problem

The present invention has been made in an effort to solve the above-mentioned problems, and an object of the present invention is to provide a smoke and toxic gas suction removal-type firefighting nozzle device, which suctions and removes ambient smoke and toxic gas concurrently with water spraying, thereby ensuring a visual field to greatly assist firefighters to quickly enter a fire site, preventing the risk of injuries or the like caused by various types of accidents to the firefighters due to smoke and toxic gas that block the visual field, allowing the firefighters to quickly enter the fire site and more quickly extinguish a fire and save human lives.

### Technical Solution

As a technical solution for achieving the above-mentioned object, a smoke and toxic gas suction removal-type firefighting nozzle device according to the present invention, which receives water supplied from a fire hose and sprays the water forward through an inner passage thereof, includes: a spray head having a plurality of intake holes configured to open the inner passage to the outside; and a gas introduction guider embedded in the spray head and configured to guide inlet gas introduced into the spray head through the intake holes and mix the inlet gas with the water by the Venturi effect occurring when the water is sprayed.

In addition, as the technical solution for achieving the above-mentioned object, a smoke and toxic gas suction removal-type firefighting nozzle device according to the present invention includes: a connection body coupled to an end of a fire hose through a hose connection part and configured to receive water and allow the water to pass therethrough; a hollow slider pipe fixed to a front side of the connection body and configured to provide an external thread portion; a spray head screw-coupled to the external thread portion of the slider pipe and configured to move forward or rearward while rotating, the spray head having a plurality of intake holes; a shaft having one end fixed into the connection body and configured to extend to the inside of the spray head while passing through the slider pipe; a deflector fixed to an extension end of the shaft and configured to collide with sprayed water in a state in which the deflector is positioned in the spray head, the deflector being configured to adjust a spread angle of the sprayed water depending on a forward or rearward movement of the spray head; and a gas guide means installed in the spray head and configured to guide a flow of outside gas and mix water with the outside gas, the outside gas being introduced into the spray head through the intake holes by negative pressure generated by the Venturi effect occurring when the water is sprayed through the spray head.

In addition, the intake holes may be disposed at equal intervals in a circumferential direction of the spray head, and the gas guide means may include: a fixing part which is a hollow member configured to allow water to pass therethrough, the fixing part being fixed into the spray head; and a gas guide part integrated with the fixing part and configured to cover the intake holes, the gas guide part being configured to guide the gas, which is introduced through the intake holes, to an outer peripheral surface thereof and guide the gas to a flow field of water.

Further, the intake holes may be disposed at equal angles in a circumferential direction of the spray head, and the gas guide means may include a gas introduction guider which is a hollow member configured to allow water to pass therethrough, the gas introduction guider being fixed to a sliding pipe and configured to cover the intake holes, guide the gas, which is introduced through the intake holes, to an outer peripheral surface thereof and send the gas to a flow field of water.

In addition, the smoke and toxic gas suction removal-type firefighting nozzle device may further include a surfactant supply means configured to inject a surfactant into the connection body and mix water with the surfactant and gas such that the water in a bubbled state is sprayed, in which the smoke and toxic gas suction removal-type firefighting nozzle device serves as a chemical pick-up-type bubble firefighting nozzle.

Further, the connection body may further include a handle configured to be gripped by a user, a supply line may include: an inner hose having one end exposed into the connection body, and the other end opened to the outside of the handle through the hose connection part; and a supply hose separably coupled to the hose connection part and configured to guide the surfactant to the inner hose, and the smoke and toxic gas suction removal-type firefighting nozzle device may serve as a chemical pick-up-type bubble firefighting nozzle.

In addition, as the technical solution for achieving the above-mentioned object, a smoke and toxic gas suction removal-type firefighting nozzle device according to the present invention includes: a hollow pipe-shaped connection body extending in a longitudinal direction thereof and including a strike part configured to be struck by a hammer, and a hose connection part coupled to a fire hose; a spray head including a piercing casing fixed to a tip portion of the connection body and having a plurality of intake holes, and a piercing tip fixed to the piercing casing and having a spray port through which water passing through an internal space of the piercing casing is sprayed, the piercing tip being configured to penetrate a front object when the strike part is struck; and a gas introduction guider accommodated in the piercing casing and configured to guide a flow of gas, which is introduced through the intake holes by the Venturi effect occurring when the water is sprayed, and mix the gas with the water.

In addition, the gas introduction guider may be fixed to an end of the connection body and provided in the form of a hollow pipe that is spaced apart from an inner peripheral surface of the piercing casing at a predetermined interval and covers the intake holes.

### Advantageous Effects

The smoke and toxic gas suction removal-type firefighting nozzle device of the present invention configured as described above can generate the negative pressure while spraying water and suction and remove ambient smoke and toxic gas by using the negative pressure, thereby assisting in ensuring the visual field of the firefighter and minimizing damage caused by the toxic gas.

In addition, the water is sprayed in the state in which the water is mixed with the inert gas such as 78% of nitrogen gas (unaffected nitrogen) in the smoke and toxic gas, which makes it possible to more effectively extinguish a fire than the case in which only water is sprayed.

### DESCRIPTION OF DRAWINGS

FIGS. 1 and 2 are perspective views of a smoke and toxic gas suction removal-type firefighting nozzle device according to a first embodiment of the present invention.

FIGS. 3 to 6A and 6B are views for explaining an internal configuration of the nozzle device illustrated in FIG. 1.

FIG. 7 is a view illustrating a modified example of the nozzle device according to the first embodiment of the present invention.

FIG. 8 is a perspective view illustrating separately enlarged part A in FIG. 7.

FIGS. 9 to 12 are views for explaining a direct spray fire nozzle (only for fire extinguishing) of the nozzle device according to the first embodiment of the present invention.

FIG. 13 is a perspective view of a piercing nozzle device according to a second embodiment of the present invention.

FIGS. 14A and 14B are views separately illustrating a spray head of the piercing nozzle device illustrated in FIG. 13.

### BEST MODE

Hereinafter, one embodiment according to the present invention will be described in more detail with reference to the accompanying drawings.

A firefighting nozzle device of the present invention sucks ambient smoke and toxic gas while spraying water toward flames and applies smoke and toxic gas, which are dissolved in or mixed with the water, into flames, thereby assisting in ensuring a visual field of a firefighter, minimizing damage caused by the smoke and toxic gas, and more efficiently extinguishing a fire than a case in which only water is sprayed. The firefighting nozzle device simultaneously performs two functions of removing smoke and toxic gas while extinguishing the flames by using water.

The present invention is based on the fact that pressure in a spray head is decreased by the Venturi effect while water is sprayed through the spray head, the fact that most of smoke and toxic gas are water soluble and removed by being dissolved in water, and the fact that the smoke and toxic gas contain a trace amount of oxygen but contain about 78% or more of inert gas such as nitrogen gas (unaffected nitrogen), such that the smoke and toxic gas are not dissolved in water but smother the flames.

In the present invention, a gas intake hole is formed in the spray head to use the Venturi phenomenon. By forming the intake hole, ambient smoke and toxic gas may be introduced. The sucked ambient smoke and toxic gas may be removed by dissolution, and the nitrogen gas may be applied into flames. This configuration will be described below in detail.

The nozzle device of the present invention includes a basic configuration including: a spray head configured to receive water supplied from a fire hose and spray the water forward through an inner passage thereof, the spray head having a plurality of intake holes that opens the inner passage to the outside; and a gas introduction guider embedded in the spray head and configured to guide a flow of gas flowing into the spray head through the intake hole by the Venturi phenomenon implemented by the sprayed water such that the inlet gas is mixed with water.

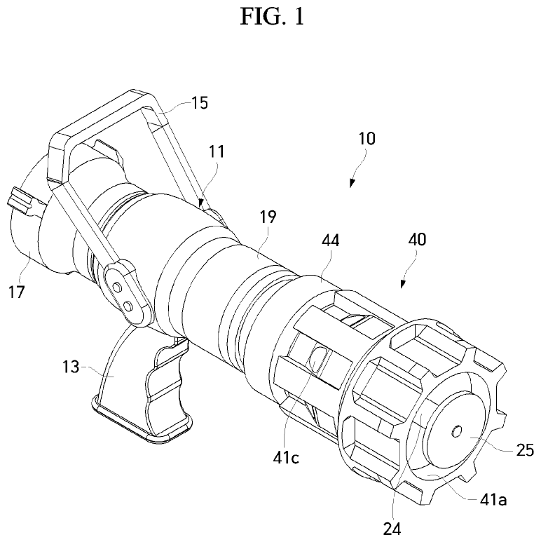

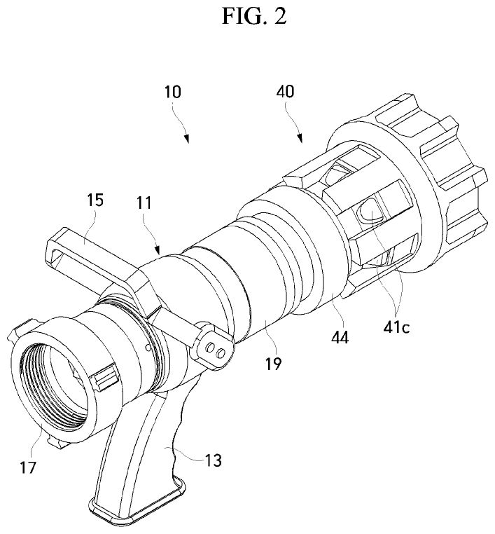

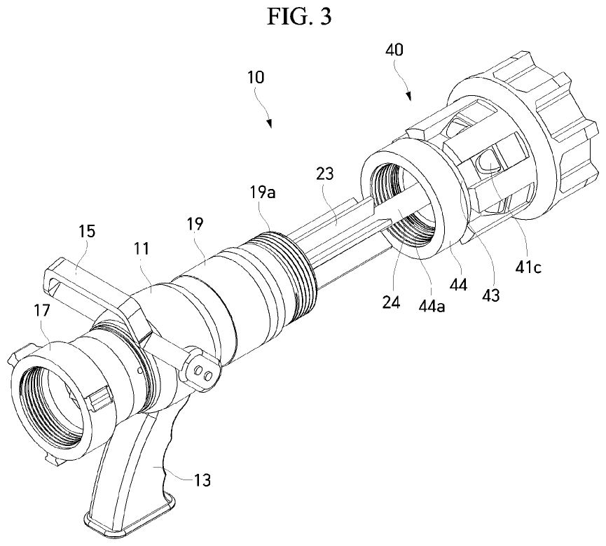

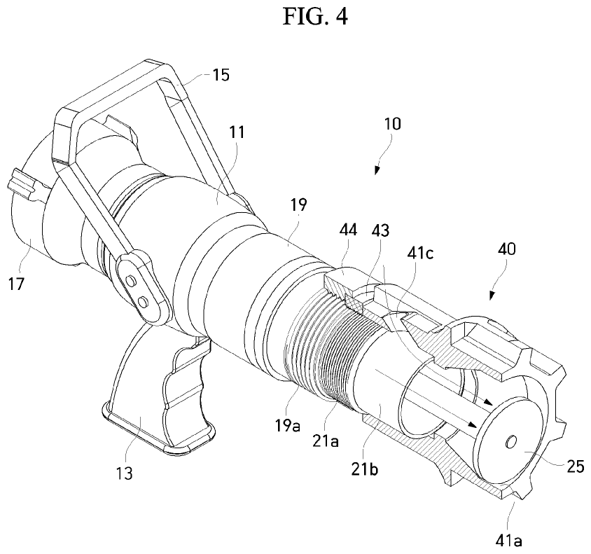

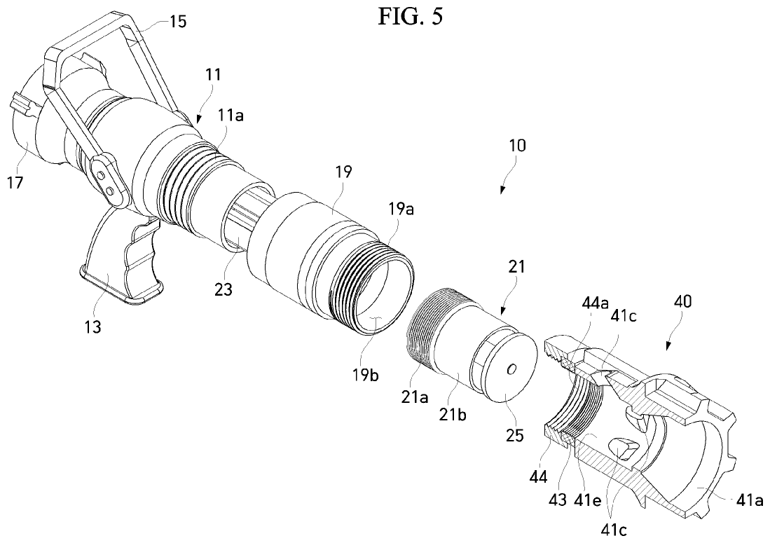

FIGS. 1 and 2 are perspective views of a smoke and toxic gas suction removal-type firefighting nozzle device 10 according to a first embodiment of the present invention, and FIGS. 3 to 6A and 6B are views for explaining an internal configuration of the nozzle device illustrated in FIG. 1.

As illustrated, the smoke and toxic gas suction removal-type firefighting nozzle device 10 according to the present embodiment includes a connection body 11, a slider pipe 19, a spray head 40, a shaft 24, a deflector 25, a direct spray guide blade 23, and a gas guide means.

The connection body 11 is connected to a fire hose and has a hose connection part 17 disposed at a rear side thereof. An end of the fire hose is detachably coupled to the hose connection part 17. Water, which is supplied through the fire hose, passes through the connection body 11 and sequentially passes through the slider pipe 19, the gas guide means, and the spray head 40 and is then sprayed forward.

A lever 15 and a handle 13 are respectively installed on upper and lower portions of the connection body 11. The lever 15 serves to open or close a ball valve (not illustrated) embedded in the connection body 11. The lever 15 may be used to spray water or stop the water spraying. The handle 13 is a portion that a user grips with his/her hand. In addition, a screw thread portion 11a is provided at a tip portion of the connection body 11. The screw thread portion 11a is a portion to which the slider pipe 19 is coupled.

The slider pipe 19 is a cylindrical member coupled to the screw thread portion 11a, and an external thread portion 19a is provided at an end of the slider pipe 19. The external thread portion 19a is screw-coupled to a slider pipe connection part 44 to be described below. The slider pipe connection part 44 is rotatable in two directions in a state of being supported on the slider pipe 19. The spray head 40 moves forward or rearward as the slider pipe connection part 44 rotates in two directions.

Further, the direct spray guide blade 23 and the shaft 24 are provided inside the connection body 11 and the slider pipe 19. The direct spray guide blade 23 is a guide wall that straightens a stream line of water flowing toward the spray head 40. In addition, the shaft 24 is a round-bar-shaped member that is fixed to a central axis portion of the slider pipe 19 and extends forward. The deflector 25 is provided at an extension end of the shaft 24. The shaft 24 serves to fix the deflector 25. The deflector 25 is a circular-plate-shaped member fixed to the extension end of the shaft and configured to collide with water sprayed through the spray head.

Because the connection body 11, the slider pipe 19, the shaft 24, the deflector 25, and the direct spray guide blade 23 are identical in configuration to those of a general firefighting nozzle, any further description thereof will be omitted.

Meanwhile, the spray head 40 may be rotated in a leftward/rightward direction by a user in the state in which the spray head 40 is screw-coupled to the external thread portion 19a of the slider pipe 19. The user may rotate the spray head 40 clockwise or counterclockwise. Of course, the spray head 40 moves forward or rearward as the spray head 40 rotates.

Because the deflector 25 is kept fixed to the shaft 24, a minimum interval of an inner peripheral surface 41e of the head with respect to an outer peripheral edge portion of the deflector 25 is changed when the spray head 40 moves forward or rearward, which causes a spread angle of the sprayed water to be changed.

The spray head 40 serves to receive water supplied from an upstream side and spray the water forward and has a plurality of intake holes 41c opened in a lateral direction thereof. The intake holes 41c are through-holes disposed at predetermined intervals in a circumferential direction of the spray head 40 and open an internal space of the spray head 40 to the outside. The water passing through the spray head 40 is not discharged to the outside through the intake holes 41c. This is because the intake holes 41c are covered to some extent by a gas guide part 21b to be described below and negative pressure is formed in a spray port 41a of the spray head 40 by the Venturi effect. When the negative pressure is formed, outside gas is, of course, introduced into the spray port 41a through the intake holes 41c.

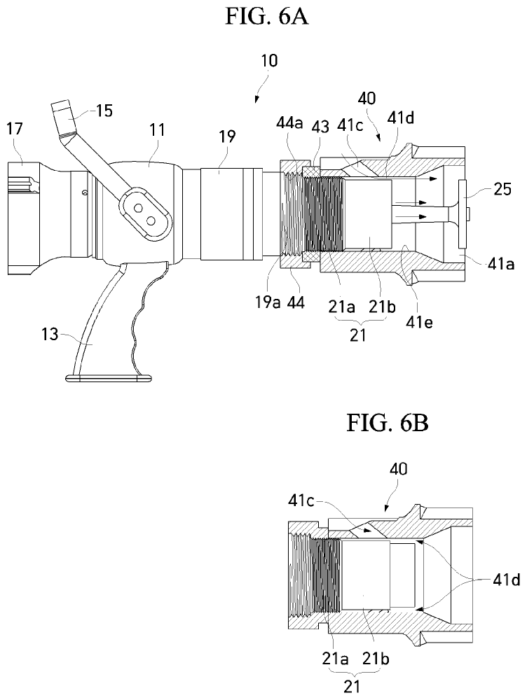

A coupling part 43 and the slider pipe connection part 44 are sequentially fixed to a rear side of the spray head 40. The coupling part 43 is a ring-shaped member having an internal thread formed on an inner peripheral surface thereof. The coupling part 43 is screw-coupled to a fixing part 21a of a gas introduction guider 21. Because the fixing part 21a is fixed to the coupling part 43, the gas introduction guider 21 is kept fixed into the spray head 40, as illustrated in FIGS. 6A and 6B.

The slider pipe connection part 44 is a ring-shaped member having an internal thread part 44a and fixed to a rear side of the coupling part 43. The external thread portion 19a is screw-coupled to the internal thread part 44a. As described above, because the slider pipe connection part 44 and the external thread portion 19a are connected to each other, it is possible to adjust a spread angle of water stream by rotating the spray head 40 leftward and rightward.

In the present embodiment, the gas introduction guider 21 is used as a gas guide means. The gas introduction guider 21 is a cylindrical member fixed into the spray head 40 and having a predetermined diameter. The gas introduction guider 21 has the fixing part 21a and the gas guide part 21b. The fixing part 21a is a portion having an external thread formed on an outer peripheral surface thereof. The fixing part 21a is screw-coupled to the coupling part 43.

In addition, the gas guide part 21b is a portion that covers the intake holes 41c. The gas guide part 21b defines a gas flow passage 41d by being spaced apart from the inner peripheral surface 41e of the spray head 40 at a predetermined interval without being in close contact with the inner peripheral surface 41e of the spray head 40. The gas flow passage 41d is a passage through which toxic gas introduced through the intake hole 41c passes. After the toxic gas passes through the gas flow passage 41d, the toxic gas meets and is mixed with the water passing through the gas introduction guider 21.

Meanwhile, the negative pressure is formed in the spray head 40 by the Venturi effect. That is, this is because a cross-sectional flow area of water passing through the periphery of the deflector 25 is smaller than a cross-sectional flow area of water passing through the gas introduction guider 21. As well known, under the same flow rate, a flow velocity increases when a cross-sectional flow area of a fluid decreases, and pressure decreases when a flow velocity increases.

In the present embodiment, because the cross-sectional flow area at the periphery of the deflector 25 is remarkably smaller than a cross-sectional flow area of the gas introduction guider, the pressure in the spray head 40 inevitably decreases. Therefore, the toxic gas outside the spray head 40 passes through the intake holes 41c and the gas flow passage 41d and is then mixed with water (sprayed from the gas guide part 21b) in the spray head 40.

Among various types of smoke and toxic gas introduced into the spray head 40, the introduced liquid particulate-based toxic gas is removed by dissolution and dilution in water, solid particulate-based soot, black dirt, fine particulate matter, and the like are subjected to physical adsorption and sprayed together with the water, and the remaining nitrogen (N₂) gas that is in a state mixed with water is sprayed into flames so that the flames are cooled and extinguished by smothering. Inert gas such as about 78% of nitrogen gas (unaffected nitrogen) obtains the kinetic energy of water and is applied into flames. Therefore, it is possible to more quickly extinguish a fire than the case in which only water is sprayed. The configuration in which a fire may be quickly extinguished without a separate additional device has a significant meaning.

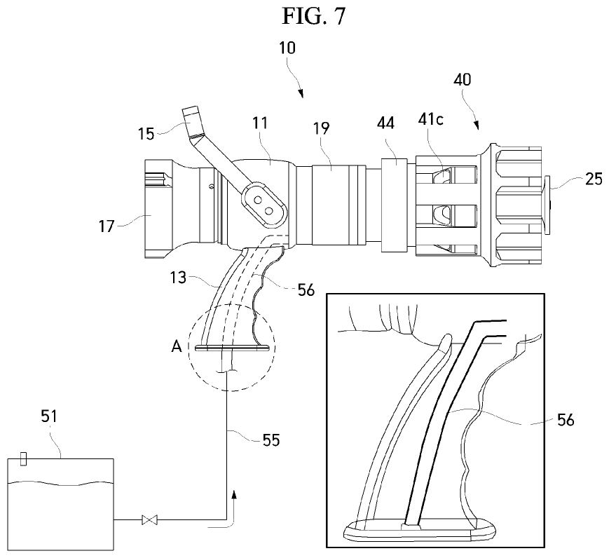

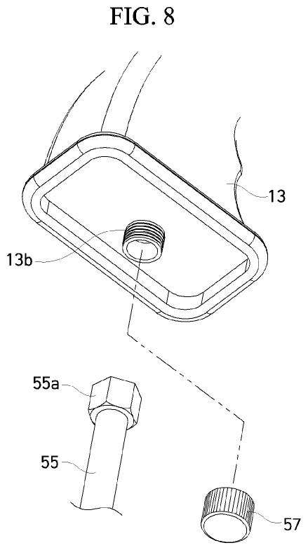

FIG. 7 is a view illustrating a modified example of the nozzle device 10 according to the first embodiment of the present invention, and FIG. 8 is a perspective view illustrating separately enlarged part A in FIG. 7.

Referring to the drawings, it can be seen that the firefighting nozzle device 10 further includes a surfactant supply means. The surfactant supply means is a device configured to inject a surfactant into the connection body 11. Because the surfactant is injected into the connection body 11, water may be bubbled by being mixed with the surfactant and toxic gas, and the bubbled water may be sprayed into flames.

As well known, in the event of an oil or gas fire, foam, which is made by mixing air with a foam aqueous solution, is mainly sprayed into a fire site to efficiently extinguish a fire in a dangerous goods reservoir, an outdoor oil tank, a liquefied gas reservoir, an aircraft hangar, a chemical plant, or the like.

The surfactant supply means may include a surfactant tank 51 and a supply line. The surfactant tank 51 is a container that accommodates the surfactant. The surfactant tank 51 may be mounted in a fire engine and carry chemicals in a dedicated container.

The supply line serves to guide the surfactant into the connection body 11. On the basis of an ejector principle, the surfactant is introduced into a portion with a high flow velocity, such that the surfactant in the surfactant tank 51 is introduced into the connection body 11 through a supply hose 55 and an inner hose 56.

The inner hose 56 is a tube embedded in the handle 13. One end of the inner hose 56 is exposed into the connection body 11, and the other end of the inner hose 56 is opened to the outside of a lower end of the handle through a hose connection part 13b. The hose connection part 13b is a component having an external thread formed on an outer peripheral surface thereof. As illustrated in FIG. 8, the hose connection part 13b may be coupled to a cap 57 or a fixing nut 55a of the supply hose 55.

When the fixing nut 55a is connected to the hose connection part 13b, the supply hose 55 and the inner hose 56 are coupled to and communicate with each other. In addition, the inner hose 56 is sealed by removing the fixing nut 55a from the hose connection part 13b and fixing the cap 57 to the position at which the fixing nut 55a has been positioned. When the inner hose is not used, the cap 57 needs to be fixed to prevent foreign substances from entering the inner hose 56.

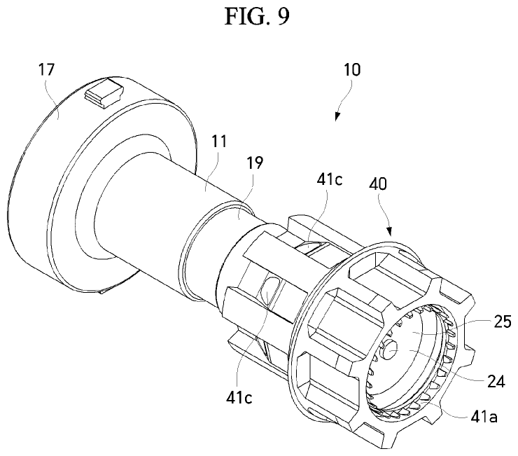

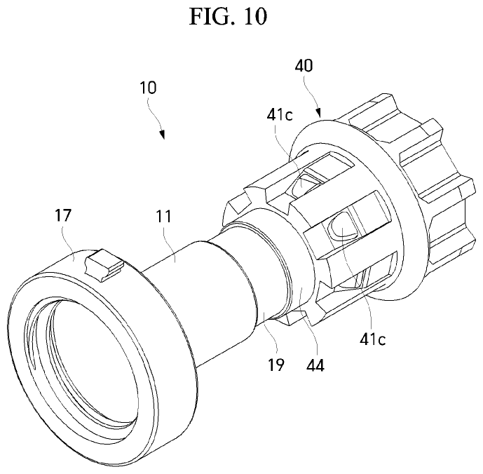

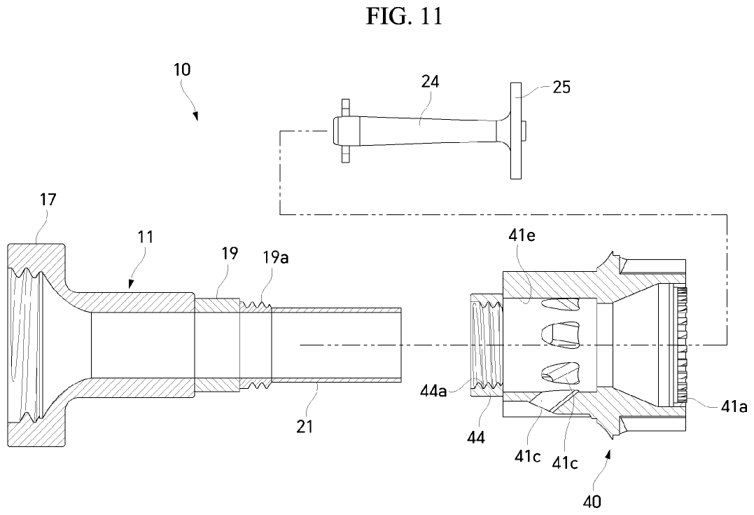

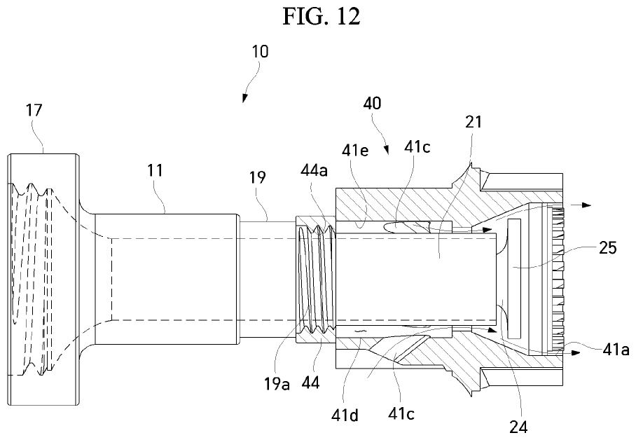

FIGS. 9 to 12 are views for explaining a modified example of the nozzle device according to the first embodiment of the present invention. The illustrated nozzle device is a direct spray fire nozzle, i.e., a small-scale nozzle mainly mounted in a fireplug in a building.

Hereinafter, the reference numerals identical to the above-mentioned reference numerals indicate the same members having the same functions.

As illustrated, the nozzle device 10 according to the modified example includes the connection body 11, the slider pipe 19, the gas introduction guider 21, and the spray head 40. The nozzle device 10 illustrated in FIG. 9 has a simpler structure, and the handle and the lever, which have been described above, are excluded.

The connection body 11 is coupled to the fire hose through the hose connection part 17, receives water, and allows the water to pass therethrough. In addition, the slider pipe 19 is fixed to the connection body 11 and supports the spray head 40 by means of the external thread portion 19a so that the spray head 40 is rotatable.

The gas introduction guider 21 is provided in the form of a simple hollow pipe and fixed to the external thread portion 19a of the slider pipe 19. The gas introduction guider 21 allows water to pass through the inside of the gas introduction guider 21 and provides the gas flow passage 41d to the outside. That is, the gas introduction guider 21 guides the gas, which is introduced through the intake hole, to an outer peripheral surface thereof and sends the gas to the deflector 25. The toxic gas, which is introduced into the intake hole 41c, passes through the gas flow passage 41d and then is sprayed forward while being mixed with water. The principle that the outside toxic gas is introduced into the spray head 40 is based on the Venturi effect described above. FIGS. 9 to 12 illustrate a direct spray fire nozzle mainly mounted in a fireplug in a building.

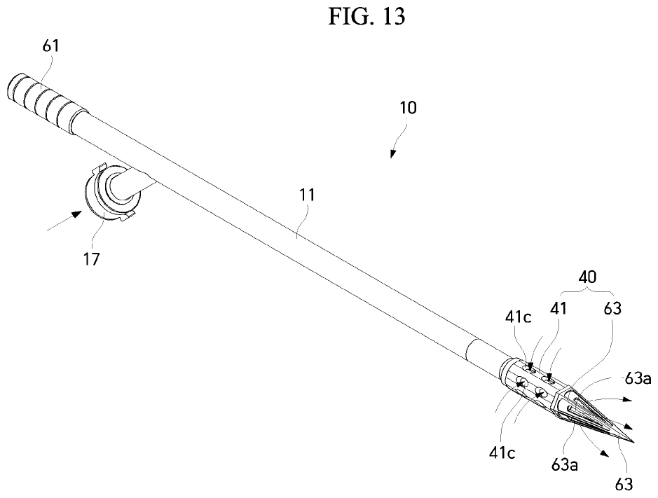

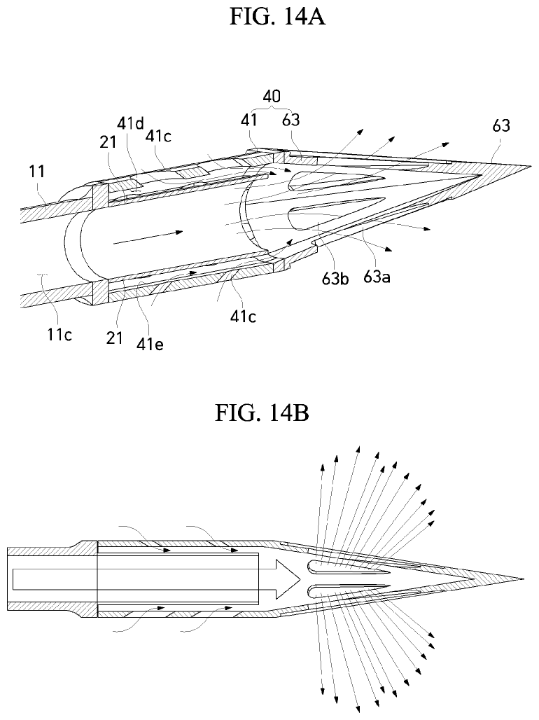

FIG. 13 is a perspective view of a nozzle device according to a second embodiment of the present invention, and FIGS. 14A and 14B are views of a piercing nozzle (fire piercing nozzle), separately illustrating a spray head of the nozzle device illustrated in FIG. 13.

For example, the nozzle device 10 according to the second embodiment is a piercing nozzle having a piercing function. As well known, in the event of a fire in a closed space, the piercing nozzle serves to pierce a fireproof door or wall and spray fire water into the space.

The nozzle device 10 according to the second embodiment includes the connection body 11, the spray head 40, and the gas introduction guider 21.

The connection body 11 is a straight hollow pipe extending in a longitudinal direction thereof and has a strike part 61 and the hose connection part 17.

The strike part 61 is a part that is subjected to a strike by a hammer. When a tip portion of the nozzle device 10, i.e., a portion of the spray head 40 is positioned on a wall and then the strike part 61 is struck, the nozzle device 10 penetrates the wall, like a nail entering the wall. In addition, the hose connection part 17 is a portion to which the fire hose is connected. When the spray head 40 enters the fire space, the fire hose is connected to the hose connection part 17, and then water is supplied, the water is sprayed into the fire space.

Meanwhile, the spray head 40 includes a piercing casing 41 and a piercing tip 63. The piercing casing 41 is a cylindrical member having an inner diameter larger than an inner diameter of the connection body 11 and has the plurality of intake holes 41c disposed at the periphery thereof. The intake hole 41c is a passage into which ambient toxic gas is introduced.

The piercing tip 63 is a member fixed to the piercing casing 41 and has a sharp tip portion. Further, the piercing tip 63 has a plurality of spray ports 63a. The spray port 63a is a hole through which the water passing through the connection body 11 and the gas introduction guider 21 is sprayed. Of course, an overall cross-sectional flow area of the spray ports 63a is relatively smaller than a cross-sectional flow area of the gas introduction guider 21. The water passing through the gas introduction guider 21 accelerates while passing through the spray port 63a. The pressure at the periphery of the spray port 63a is dropped, and the Venturi phenomenon occurs.

The gas introduction guider 21 is a hollow pipe having a predetermined diameter and fixed to an end of the connection body 11. An inner diameter of the gas introduction guider 21 is equal to an inner diameter of the connection body 11. The gas introduction guider 21 is spaced apart from an inner peripheral surface of the piercing casing 41 at a predetermined interval and covers the intake holes 41c. Further, an outer peripheral surface of the gas introduction guider 21 provides the gas flow passage 41d between the outer peripheral surface of the gas introduction guider 21 and an inner peripheral surface of the piercing casing.

As a result, the toxic gas at the periphery of the spray head 40 passes through the intake hole 41c and the gas flow passage 41d and then is discharged while being mixed with water in the piercing tip 63 by the Venturi effect occurring at the periphery of the spray port 63a when the water is sprayed.

As a result, according to the toxic gas suction removal-type firefighting nozzle device 10 according to the first and second embodiments configured as described above, among the ambient smoke and toxic gas suctioned and introduced concurrently with water spraying, liquid particulate-based toxic gas is removed by dissolution and dilution in water, solid particulate-based soot, black dirt, fine particulate matter, and the like are subjected to physical adsorption, and the remaining nitrogen (N₂) gas mixed with water is sprayed into flames so that the flames are cooled and extinguished by smothering. For example, inert gas such as about 78% of nitrogen gas (unaffected nitrogen) obtains the kinetic energy of water and is applied into flames.

Therefore, it is possible to ensure the visual field of the firefighter, minimize damage caused by toxic gas, and more efficiently extinguish a fire than the case in which only water is sprayed.

While the present invention has been described above in detail with reference to the specific embodiments, the present invention is not limited to the embodiments but may be variously modified by those skilled in the art without departing from the technical spirit of the present invention.

1. A smoke and toxic gas suction removal-type firefighting nozzle device, which receives water supplied from a fire hose and sprays the water forward through an inner passage thereof, comprising:
a spray head having a plurality of intake holes configured to open the inner passage to the outside; and
a gas introduction guider embedded in the spray head and configured to guide inlet gas introduced into the spray head through the intake hole and mix the inlet gas with the water by the Venturi effect occurring when the water is sprayed.

2. A smoke and toxic gas suction removal-type firefighting nozzle device comprising:
a connection body coupled to an end of a fire hose through a hose connection part and configured to receive water and allow the water to pass therethrough;
a hollow slider pipe fixed to a front side of the connection body and configured to provide an external thread portion;
a spray head screw-coupled to the external thread portion of the slider pipe and configured to move forward or rearward while rotating, the spray head having a plurality of intake holes;
a shaft having one end fixed into the connection body, and configured to extend to the inside of the spray head while passing through the slider pipe;
a deflector fixed to an extension end of the shaft and configured to collide with sprayed water in a state in which the deflector is positioned in the spray head, the deflector being configured to adjust a spread angle of the sprayed water depending on a forward or rearward movement of the spray head; and
a gas guide means installed in the spray head and configured to guide a flow of outside gas and mix water with the outside gas, the outside gas being introduced into the spray head through the intake holes by negative pressure generated by the Venturi effect occurring when the water is sprayed through the spray head.

3. The smoke and toxic gas suction removal-type firefighting nozzle device of claim 2, wherein the intake holes are disposed at equal intervals in a circumferential direction of the spray head, and
wherein the gas guide means comprises:
a fixing part which is a hollow member configured to allow water to pass therethrough, the fixing part being fixed into the spray head; and
a gas guide part integrated with the fixing part and configured to cover the intake holes, the gas guide part being configured to guide the gas, which is introduced through the intake holes, to an outer peripheral surface thereof and guide the gas to a flow field of water.

4. The smoke and toxic gas suction removal-type firefighting nozzle device of claim 2, wherein the intake holes are disposed at equal angles in a circumferential direction of the spray head, and
wherein the gas guide means comprises a gas introduction guider which is a hollow member configured to allow water to pass therethrough, the gas introduction guider being fixed to a sliding pipe and configured to cover the intake holes, guide the gas, which is introduced through the intake holes, to an outer peripheral surface thereof and send the gas to a flow field of water.

5. The smoke and toxic gas suction removal-type firefighting nozzle device of claim 2, further comprising:
a surfactant supply means configured to inject a surfactant into the connection body and mix water with the surfactant and gas such that the water in a bubbled state is sprayed,
wherein the smoke and toxic gas suction removal-type firefighting nozzle device serves as a chemical pick-up-type bubble firefighting nozzle.

6. The smoke and toxic gas suction removal-type firefighting nozzle device of claim 5, wherein the connection body further comprises a handle configured to be gripped by a user,
wherein a supply line comprises:
an inner hose having one end exposed into the connection body, and the other end opened to the outside of the handle through the hose connection part; and
a supply hose separably coupled to the hose connection part and configured to guide the surfactant to the inner hose, and
wherein the smoke and toxic gas suction removal-type firefighting nozzle device serves as a chemical pick-up-type bubble firefighting nozzle.

7. A smoke and toxic gas suction removal-type firefighting nozzle device comprising:
a hollow pipe-shaped connection body extending in a longitudinal direction thereof and comprising a strike part configured to be struck by a hammer, and a hose connection part coupled to a fire hose;
a spray head comprising a piercing casing fixed to a tip portion of the connection body and having a plurality of intake holes, and a piercing tip fixed to the piercing casing and having a spray port through which water passing through an internal space of the piercing casing is sprayed, the piercing tip being configured to penetrate a front object when the strike part is struck; and
a gas introduction guider accommodated in the piercing casing and configured to guide a flow of gas, which is introduced through the intake holes by the Venturi effect occurring when the water is sprayed, and mix the gas with the water.

8. The smoke and toxic gas suction removal-type firefighting nozzle device of claim 7, wherein the gas introduction guider is fixed to an end of the connection body and provided in the form of a hollow pipe that is spaced apart from an inner peripheral surface of the piercing casing at a predetermined interval and covers the intake holes.
